(19) United States
(12) Patent Application Publication
(10) Pub. No.: US 2016/0019424 A1
(43) Pub. Date: Jan. 21, 2016

(54) OPTICAL TOUCH-CONTROL SYSTEM

(71) Applicant: Quanta Computer Inc., Kuei Shan Hsiang (TW)

(72) Inventors: Yun-Cheng Liu, Kuei Shan Hsiang (TW); Chin-Kang Chang, Kuei Shan Hsiang (TW); Chao-Ching Huang, Kuei Shan Hsiang (TW)

(21) Appl. No.: 14/463,964

(22) Filed: Aug. 20, 2014

(30) Foreign Application Priority Data
Jul. 15, 2014 (TW) 103124207

(51) Int. Cl. G06K 9/00; G06T 7/20; G06T 7/00

(52) U.S. Cl. CPC G06K 9/00711; G06K 9/00718; G06T 7/0071; G06T 7/20; G06K 2009/00738

(57) ABSTRACT

An optical touch-control system is provided. The optical touch-control system includes a display unit; a light source; an image capturing unit, configured to capture a plurality of images reflected by the light emitted by the light source in front of the display unit; and a processor, wherein the processor determines whether a target object is located in an operating space in front of the display unit based on the captured images, wherein when the processor determines that the target object is in a touch zone of the operating space, the processor further determines that the target object is to perform a touch-control operation, wherein when the processor determines that the target object is in a gesture zone of the operating space, the processor further determines that the target object is to perform a gesture operation.

### CROSS REFERENCE TO RELATED APPLICATIONS

This Application claims priority of Taiwan Patent Application No. 103124207, filed on Jul. 15, 2014, the entirety of which is incorporated by reference herein.

### BACKGROUND OF THE INVENTION

1. Field of the Invention

The present invention relates to an optical system, and, in particular, to an optical touch-control system capable of determining touch positions by using optical devices.

2. Description of the Related Art

With advances in technology, electronic devices having a touch panel, such as smartphones, smart TVs, laptops, and touch screens, have become more and more popular. However, the electronic devices of some users do not have the touch-control function, such as conventional LCD/LED TVs or displays. Accordingly, if the users want to perform touch-control functions on their existing electronic device, they have to buy a new TV or display having touch-control functionality, resulting in a burden to users.

### BRIEF SUMMARY OF THE INVENTION

A detailed description is given in the following embodiments with reference to the accompanying drawings.

In an exemplary embodiment, an optical touch-control system is provided. The optical touch-control system includes a display unit; a light source; an image capturing unit, configured to capture a plurality of images reflected by the light emitted by the light source in front of the display unit; and a processor. The processor determines whether a target object is located in an operating space in front of the display unit based on the captured images, wherein when the processor determines that the target object is within a touch zone of the operating space, the processor further determines that the target object is performing a touch-control operation, wherein when the processor determines that the target object is within a gesture zone of the operating space, the processor further determines that the target object is performing a gesture operation.

### BRIEF DESCRIPTION OF THE DRAWINGS

The present invention can be more fully understood by reading the subsequent detailed description and examples with references made to the accompanying drawings, wherein:

FIG. 1 is a schematic block diagram of an optical touch-control system in accordance with an embodiment of the invention;

FIG. 2A is a top view of the optical touch-control system in accordance with an embodiment of the invention;

FIG. 2B is a side view of the optical touch-control system in accordance with an embodiment of the invention;

FIG. 2C is a diagram illustrating image capturing by the optical touch-control system in accordance with an embodiment of the invention;

FIG. 3A is a diagram illustrating depth calibration by the optical touch-control system;

FIG. 3B is a diagram of a calibration reference image in accordance with an embodiment of the invention;

FIG. 3C is a diagram of the calibration reference image in accordance with another embodiment of the invention;

FIG. 3D is a diagram of the captured image in accordance with another embodiment of the invention;

FIG. 3E is a diagram of the specific pattern emitted by the light source 120 in accordance with an embodiment of the invention;

FIG. 3F is a diagram of the specific pattern emitted by the light source 120 in accordance with another embodiment of the invention;

FIG. 4 is a diagram illustrating calculation of the depth by the optical touch-control system in accordance with an embodiment of the invention;

FIG. 5 is a diagram illustrating calculation of the touch position by the optical touch-control system in accordance with an embodiment of the invention; and

FIG. 6 is a flow chart of a touch-control method in accordance with an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

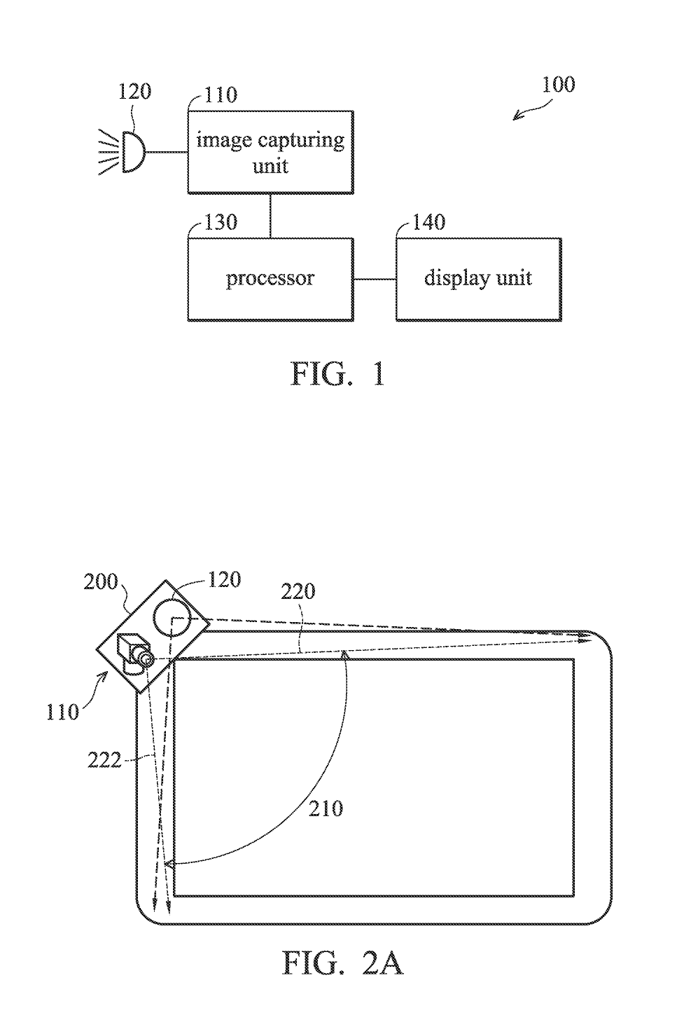

FIG. 1 is a schematic block diagram of an optical touch-control system in accordance with an embodiment of the invention. As shown in FIG. 1, the optical touch-control system 100 may comprise an image capturing unit 110, a light source 120, a processor 130, and a display unit 140. In an embodiment, the image capturing unit 110 and the light source 120 can be integrated into a camera module which is deployed on the boundary of the display unit 140. For example, the image capturing unit 110 may be an infrared camera, and the light source 120 may be an infrared light source, but the invention is not limited thereto. The image capturing unit 110 may consistently capture images of a touch object on the surface of the display unit 140. The processor 130 may analyze the captured images from the image capturing unit 110, and determine the touch object from the captured images and estimate the position of the touch object in the three-dimensional operating space.

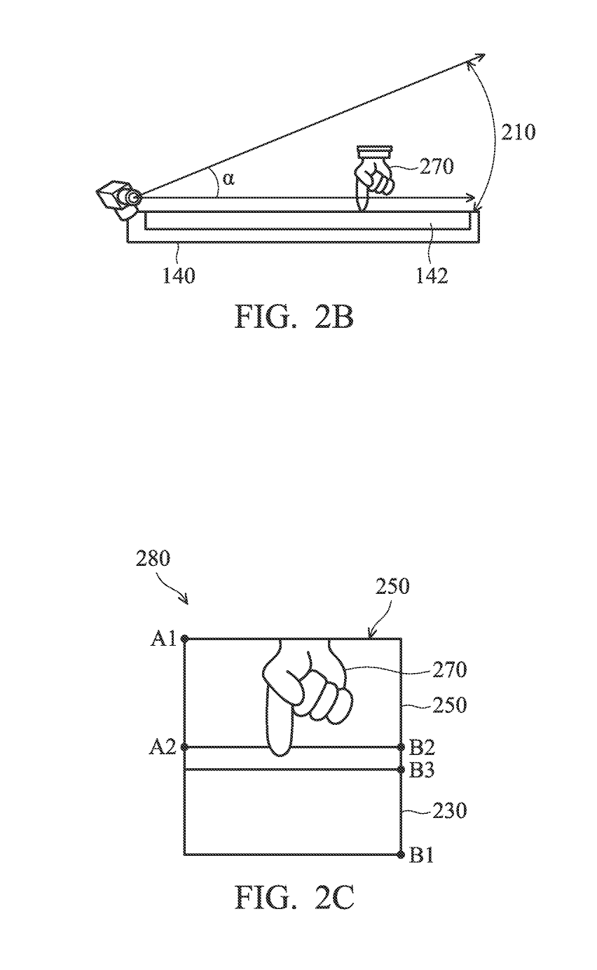

FIG. 2A is a top view of the optical touch-control system in accordance with an embodiment of the invention. FIG. 2B is a side view of the optical touch-control system in accordance with an embodiment of the invention. As shown in FIG. 2A, the camera module 200 comprising the image capturing unit 110 and the light source 120 is deployed at a corner of the display unit 140. There is an operating space 210, such as the region between the dashed lines 220 and 222 in the top view, in front of the image capturing unit 110. Referring to FIG. 2B, generally, the surface of the display unit 140 is made of a glass layer 142, and the image capturing unit 110 may capture images with a shooting angle a . Accordingly, the processor 130 may determine the position of the target object 270 (e.g. a finger, palm, or stylus) in the operating space 210 above the surface of the display unit 140.

FIG. 2C is a diagram illustrating image capturing by the optical touch-control system in accordance with an embodiment of the invention. For example, the captured image may be classified into several regions such as a glass zone 230, a touch zone 240, and a gesture zone 250. The remaining portion of the operating space 210 beyond the shooting range of the image capturing unit 110 belongs to an invalid zone. When the target object 270 is located in the touch zone 240, the processor 130 may determine that the user is to perform touch operations on the surface of the display unit 140. When the target object 270 is located in the gesture zone 250, the processor 130 may determine that the user is to perform gesture operations, and the processor 130 may calculate variation of the depth and trajectory of the target object 270 from the captured image 280, thereby determining the gesture.

Specifically, the touch zone 240 is a region above the glass zone 230 within a predetermined distance in pixels, wherein the predetermined distance may be 10 pixels, but the invention is not limited thereto. Additionally, the boundary between the touch zone 240 and the gesture zone 250 is determined based on the location of pixels in the captured image. For example, the coordinates (X_{A1}, Y_{A1}) of the upper-left point A1 in the captured image 280 are (0, 0), and the coordinates (X_{B1}, Y_{B1}) of the bottom-right point B1 are (200, 200), wherein the X axis denotes the right direction, and the Y axis denotes the down direction. For example, the upper-left corner of the gesture zone 250 is also the point A1 having a coordinate (0, 0), and the bottom-right corner of the gesture zone 250 is the point B2 having a coordinate (200, 100). The upper-left corner of the touch zone 240 is the point A2 having a coordinate (0, 100), and the bottom-right corner of the touch zone 240 is the point A3, and the coordinates (X_{A3}, Y_{A3}) of the points A3 are (200, 110). Specifically, when the target object approaches the surface of the display unit 140, gray-level information of the captured image 280 along the X axis and Y axis of the touch zone 240 is generated. The processor 130 may calculate the touch position of the target object on the surface of the display unit 140 based on the relationship between the position and depth of pixels in the captured image 280.

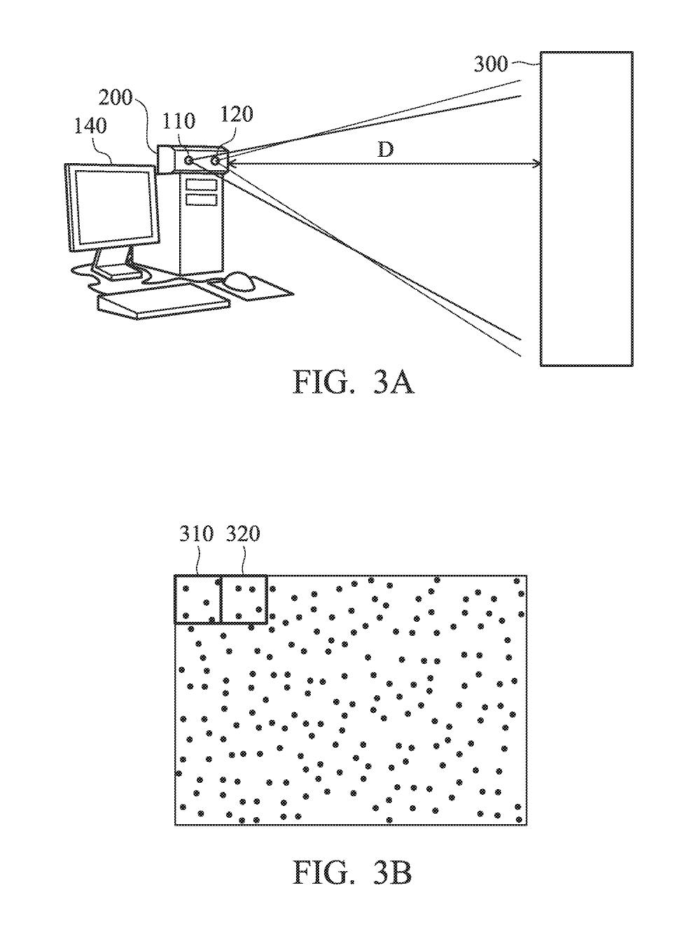

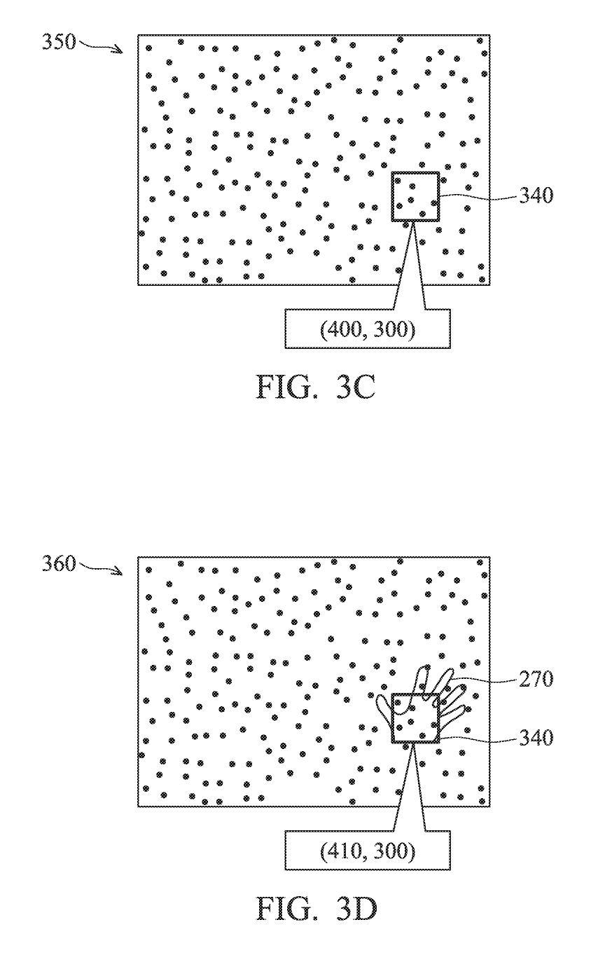

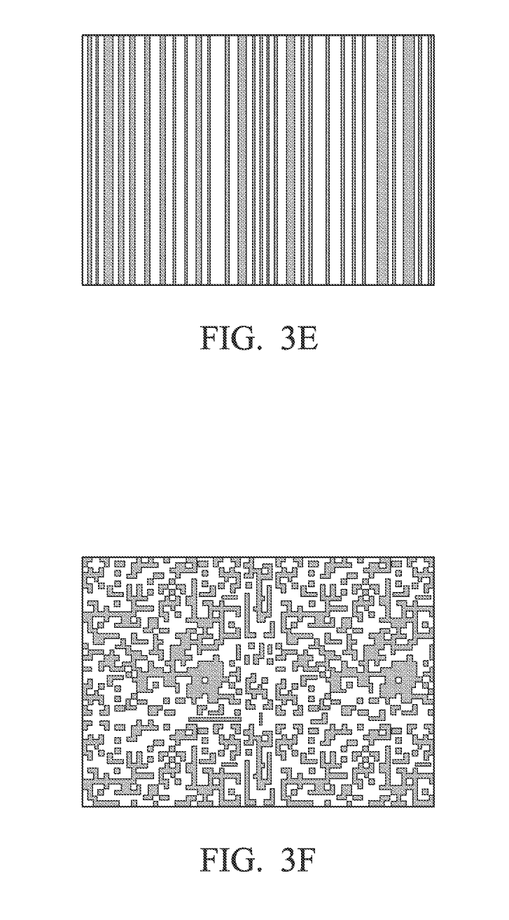

FIG. 3A is a diagram illustrating calibration of depths by the optical touch-control system. FIG. 3B is a diagram of a calibration reference image in accordance with an embodiment of the invention. As shown in FIG. 3A, a calibration reference surface 300, such as a wall, is utilized in calibrating the depths by the optical touch-control system 100. The distance between the calibration reference surface 300 and the optical touch-control system 100 is known as D, and the light source 120 of the optical touch-control system 100 may emit a calibration reference image 350 having specific patterns to the calibration reference surface 300. When the image capturing unit 110 is an infrared camera, the captured image is a gray-level image. It should be noted that, for description, FIG. 3B is illustrated by contrary gray levels. For example, as shown in FIG. 3B, the black dots (i.e. actually white dots) are the specific barcodes or specific patterns emitted by the light source 120. The specific barcodes or patterns emitted by the light source 120 are arranged in blocks, such as blocks having 8×8 pixels, and the barcodes of each block are independent from each other. For example, the barcodes in the blocks 310 and 320 are different, and the barcodes in the blocks 310 and 330 are also different.

FIG. 3C is a diagram of the calibration reference image in accordance with another embodiment of the invention. FIG. 3D is a diagram of the captured image in accordance with another embodiment of the invention. As shown in FIG. 3C, when there is no target object in the captured image, the captured image from the image capturing unit 110 is the calibration reference image 350. As shown in FIG. 3D, when a target object 270 (e.g. a palm) is in the captured image, the distance between the target object and the image capturing unit 110 is usually different from the distance D. That is, the location of the specific patterns in the block 340 of the calibration image 360 in FIG. 3C may be changed in FIG. 3D, such as by being moved toward the right a distance of 10 pixels. Meanwhile, the processor 130 may calculate the distance between the target object and the image capturing unit 110 based on the change of distance in pixels in the calibration reference image 350.

FIG. 3E is a diagram of the specific pattern emitted by the light source 120 in accordance with an embodiment of the invention. FIG. 3F is a diagram of the specific pattern emitted by the light source 120 in accordance with another embodiment of the invention. In an embodiment, the specific pattern emitted by the light source 120 may be interference bars, as shown in FIG. 3E. In another embodiment, the specific pattern emitted by the light source 120 may be two-dimensional barcodes, as shown in FIG. 3F. For one having ordinary skill in the art, it will be appreciated that the specific pattern emitted by the light source 120 is not limited to the aforementioned forms, and other specific pattern for optical pattern recognition can be used in the invention.

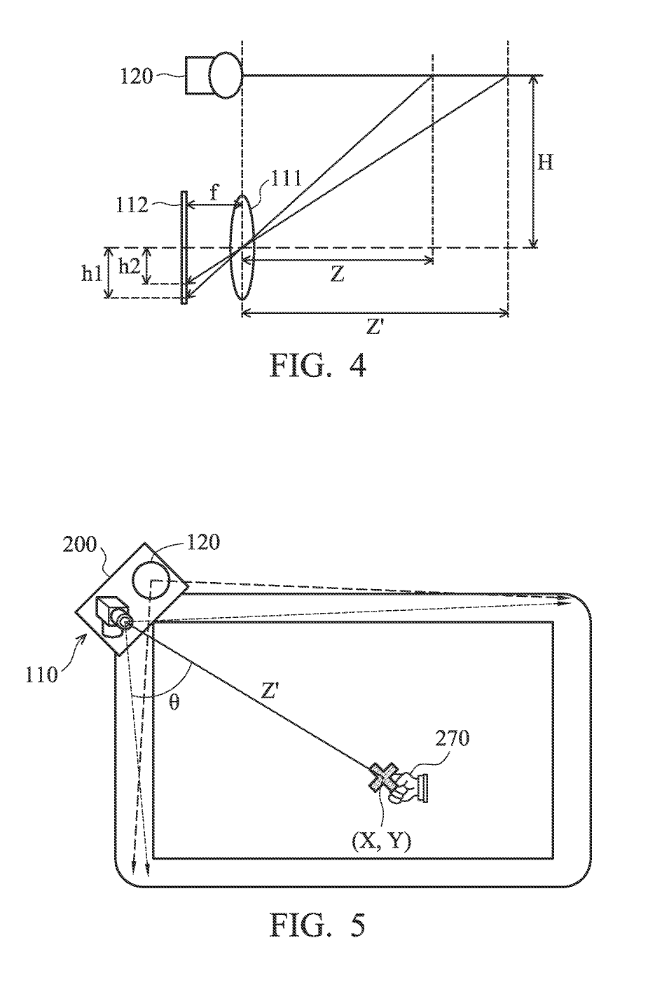

FIG. 4 is a diagram illustrating calculation of the depth by the optical touch-control system in accordance with an embodiment of the invention. In an embodiment, the image capturing unit 110 may comprise a lens 110 and a sensor array 112, wherin the sensor array 112 comprises a plurality of optical sensors such as CMOS sensors or CCD sensors. As shown in FIG. 4, the distance Z, which is known, denotes the distance from the lens 111 to the calibration reference plane 400. When the optical touch-control system 100 performs depth calibration, the light source 120 may project the calibration reference image having a specific pattern to the calibration reference plane 400. The distance H denotes the distance from the light source 120 to the center of the lens 111. The distance f denotes the distance from the lens 111 to the sensor array 112. In addition, h1 denotes the coordinates of the pixels of the specific pattern, which were previously projected on the calibration reference plane 400, reflected onto the sensor array 112, and h2 denotes the coordinates of the pixels of the specific pattern, which were previously at a specific distance Z′, reflected onto the sensor array 112, wherein the specific distance Z′ is the distance to be estimated by the processor 130.

By using optical principles, some relationships can be derived from FIG. 4 as follows:

h1/f=H/Z (1)

Z=f(h1) (2)

Z′=f(h2) (3)

Accordingly, the distance Z′ can be calculated using the equations (1), (2) and (3). That is, the distance between the target object and the image capturing unit 110 can be calculated.

FIG. 5 is a diagram illustrating calculation of the touch position by the optical touch-control system in accordance with an embodiment of the invention. As shown in FIG. 5, when the distance Z′ between the target object 500 and the image capturing unit 110 is calculated by the method shown in FIG. 4, the processor 130 may determine the angle θ between the target object 500 and the boundary of the display unit 140. Then, the processor 130 may calculate the coordinate (X, Y) of the touch position of the target object 500 on the display unit 140 by using the trigonometric functions such as X=Cosθ*Z′, and Y=Sinθ*Z′.

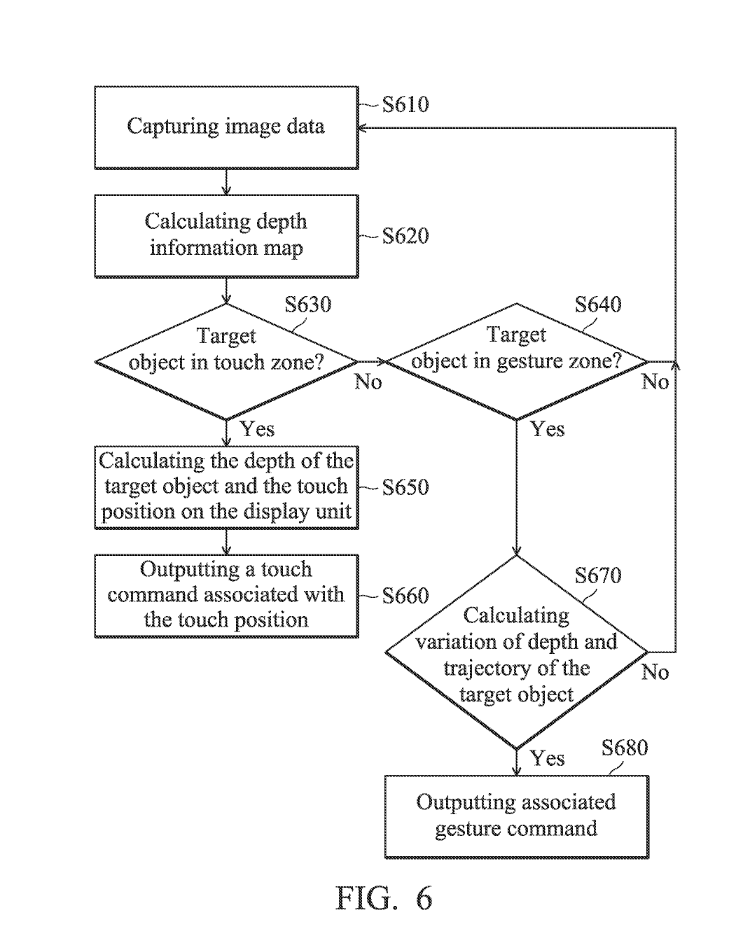

FIG. 6 is a flow chart of a touch-control method in accordance with an embodiment of the invention. In step S610, the image capturing unit 110 may consistently capture image data. In step S620, the processor 130 may calculate a depth information map based on the image data. In step S630, the processor 130 may determine whether any target object is in the touch zone. If so, step S650 is performed. Otherwise, step S640 is performed. In step S640, the processor 130 further determines whether any target object is in the gesture zone. If so, step S670 is performed. Otherwise, step S610 is performed. Specifically, when the processor 130 determines whether any target object is in the touch zone or the gesture zone, the processor 130 may determine whether the specific pattern emitted by the light source is shifted by using the method shown in FIG. 4, calculate the distance between the target object and the image capturing unit 110 (i.e. the depth of the target object), and determine whether the target object is located in the touch zone or the gesture zone.

In step S650, the processor 130 may calculate the depth of the target object and the touch position of the target object on the display unit 140. In step S660, the processor 130 may output a touch command associated with the touch position. In step S670, the processor 130 may calculate variation of the depth and the trajectory of the target object to determine a gesture. In step S680, the processor 130 may output a gesture command corresponding to the determined gesture. For those having ordinary skill in the art, it will be appreciated that the algorithms for determining gestures in steps S670 and S680 can be referred to in prior technologies, and the details will be omitted here.

In view of the above, an optical touch-control system and a touch-control method are provided. The optical touch-control system and the touch-control method are capable of performing touch-control operations and gesture operations by using an extra image capturing unit and an extra light source deployed on a conventional display or TV without touch-control functionality, thereby costing less than replacing the TV or display.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical touch-control system, comprising
a display unit;
a light source;
an image capturing unit, configured to capture a plurality of images reflected by the light emitted by the light source in front of the display unit; and
a processor, wherein the processor determines whether a target object is located in an operating space in front of the display unit based on the captured images,
wherein when the processor determines that the target object is within a touch zone of the operating space, the processor further determines that the target object is performing a touch-control operation,
wherein when the processor determines that the target object is within a gesture zone of the operating space, the processor further determines that the target object is performing a gesture operation.

2. The optical touch-control system as claimed in claim 1, wherein the light source is an infrared light source, and the image capturing unit is an infrared camera.

3. The optical touch-control system as claimed in claim 1, wherein the processor further calculates a depth information map based on the captured images, and determines whether the target object is located in the touch zone or the gesture zone based on the depth information map.

4. The optical touch-control system as claimed in claim 1, wherein when the processor determines that the target object is located in the touch zone, the processor further calculates a depth of the target object and a touch position of the target object relative to the display unit.

5. The optical touch-control system as claimed in claim 1, wherein when the processor determines that the target object is located in the gesture zone, the processor further calculates variation of a depth and a trajectory of the target object, thereby determining a gesture of the target object.

6. The optical touch-control system as claimed in claim 1, wherein the light source emits a calibration reference image comprising a plurality of blocks, and each block has associated specific patterns, and the processor further determines an offset of the specific patterns of each block to determine a depth of the target object.

7. The optical touch-control system as claimed in claim 6, wherein the specific patterns are a plurality of interference bars.

8. The optical touch-control system as claimed in claim 6, wherein the specific patterns are a plurality of two-dimensional barcodes.
